(19) United States
(12) Patent Application Publication
(10) Pub. No.: US 2016/0281900 A1
(43) Pub. Date: Sep. 29, 2016

(54) CONDUIT LINER WITH WEAR-RESISTANT ELEMENTS

(71) Applicant: SYNCRUDE CANADA LTD. in trust for the owners of the Syncrude Project as such owners exist now and, Fort McMurray (CA)

(72) Inventors: SOON WON MOON, Edmonton (CA); STEFANO CHIOVELLI, Edmonton (CA)

(21) Appl. No.: 14/668,674

(22) Filed: Mar. 25, 2015

(51) Int. Cl. F16L 55/165

(52) U.S. Cl. CPC F16L 55/1656

(57) ABSTRACT

A conduit which may be a hose defines an inner bore and has an elastomeric liner with hard material segments embedded in and backed by the liner and exposed to the inner bore. The hard material segments absorb high energy impacts while the elastomeric liner backs the segments and absorb sufficient energy to mitigate the more brittle nature of the wear-resistant segments.

### FIELD OF THE INVENTION

The present invention relates to conduits having a liner with protective wear-resistant elements, and in particular, hard material segments embedded in and backed by an elastomer.

### BACKGROUND

Mining products are frequently transported as slurries, which causes considerable wear within pipes. Large rubber hoses with rubber liners have comparatively much better wear properties, primarily due to the energy-dampening capability of the rubber liner through elastic deformation. In the same way, elastomer-lined pipes also provide good wear performance in many high wear locations.

However, when the impact energy of the solid slurry particles exceeds the elastic capability of the liner, permanent damage may result in the form of gouging or tearing of the liner. Thus, the size of solid particles, speed of the slurry flow, and flow characteristics are parameters which affect the application window of rubber hoses or elastomer-lined pipes. In particular, the speed of the slurry flow is sometimes a critical factor limiting the usage of rubber hose or elastomer-lined pipes. If a particular location is subject to high slurry flow speed, an impingement point may exist, and the liner may fail due to localized damage at the impingement point.

It is known to use wear-resistant material such as tungsten carbide overlaid pipe in such cases, however such material is prohibitively expensive.

### SUMMARY OF THE INVENTION

In one aspect, the invention may comprise a conduit, such as a pipe or a hose defining an inner bore, having an elastomeric liner comprising at least one, and preferably a plurality of embedded hard material segments, embedded in and backed by the elastomeric liner, and exposed to the inner bore.

In one embodiment, the conduit elastomeric liner comprises a rubber or a polyurethane. The hard material segment may comprise tungsten carbide, or sintered tungsten carbide, a cermet, or a ceramic material. The hard material segments may comprise a three-dimensional shape comprising tiles, blocks, cylinders, spheres, or ovoids. The hard material segments may have a two-dimensional shape which faces the conduit bore comprising squares, rectangles, circles, ovals, hexagons or other polygons, or combinations thereof.

In one embodiment, the hard material segments are tiles, which may be rectangular, and which may be parallel to or angled away from a plane which is parallel to a central axis of a conduit which is straight, or a plane tangential to the central axis of a conduit which is curved.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a cross-sectional view of one embodiment of a hose of the present invention.

FIG. 2A is a cross-sectional view in the liner along a longitudinal plane of one embodiment while FIG. 2B is a schematic view of the inner bore of the same embodiment.

FIG. 3A is a cross-sectional view in the liner along a longitudinal plane of one embodiment while FIG. 3B is a schematic view of the inner bore of the same embodiment.

FIG. 4A is a schematic view of the inner bore of one embodiment showing hexagonal tiles while FIG. 4B is a schematic view of the inner bore of an alternative embodiment of hexagonal tiles.

FIG. 5A is a schematic view of the inner bore of one embodiment showing rectangular tiles axially staggered. FIG. 5B is a schematic view of the inner bore of an alternative embodiment showing rectangular tiles longitudinally staggered.

FIG. 6 is a cross-sectional view of one embodiment, showing a simulated impact by a rock.

FIG. 7 is a cross-sectional view of an alternative embodiment, showing embedded tiles which are angled.

FIG. 8 is a view of the embodiment of FIG. 7, with rubber wear.

FIG. 9 is a cross-sectional view of an alternative embodiment, where the tiles are angled at a shallower angle than shown in FIG. 7, and with rubber wear.

FIG. 10 is a schematic representation of chemical bonding between an elastomer and a wear-resistant material, with a primer layer and an adhesive layer.

### DETAILED DESCRIPTION

As used herein, the recited terms have the following meanings. All other terms and phrases used in this specification have their ordinary meanings as one of skill in the art would understand.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described or claimed in connection with an embodiment, it is within the knowledge of one skilled in the art to affect or connect such aspect, feature, structure, or characteristic with other embodiments, whether or not explicitly described.

The present invention comprises a conduit having an elastomeric liner comprising at least one hard material segment embedded in and backed by the elastomeric liner and exposed to the conduit inner bore, and preferably a plurality of hard material segments. The embedded segments provide additional wear resistance, however, the primary role of the segments is to protect the elastomeric liner underneath. The hard material segments are positioned over the elastomeric liner at high impact/impingement locations so that the elastomeric liner underneath the segments are protected from high energy impacts. Elastomers backing the hard material segments may provide an energy dampening function, thereby reducing the net impact energy directly imparted onto the hard material segments. In this sense, embodiments of the present invention are distinct from overlay coatings of a wear-resistant material. The hard material of this invention should be segmented so that impact energy can be effectively transferred to the elastomer behind the segment.

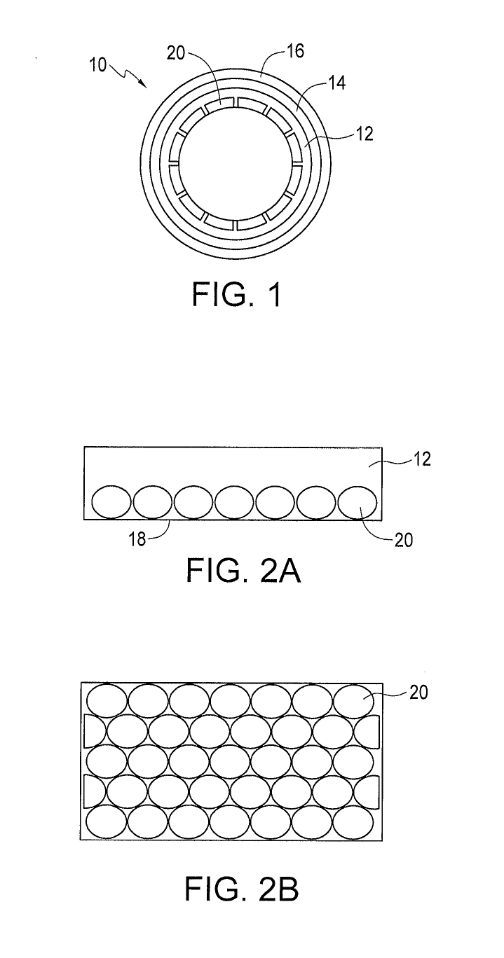

The conduit may be a pipe having a rigid outer layer, or a hose. As shown schematically in FIG. 1, in one embodiment, a hose (10) comprises an elastomeric liner (12), a reinforcing layer (14) such as a fabric reinforcing layer to provide mechanical strength to the hose, and an outer elastomeric layer (16). In elastomer-lined pipes, the liner may have a monolayer or a multilayered construction.

As used herein, a “hard material” is any material known to have greater mechanical strength than the underlying elastomer and good abrasion resistance. Such material may include, without limitation, metallic materials, ceramic or non-ceramic carbides such as chromium carbide, tungsten carbide, or a cermet such as sintered tungsten carbide. Sintered tungsten carbide, also known as cemented carbide, is a composite material comprising tungsten carbide powder mixed with a binder metal such as cobalt or nickel, compacted in a die and then sintered at a very high temperature. Wear-resistant materials may also include various ceramic materials such as alumina or a nitride such as silicon nitride. As used herein, a ceramic material is an inorganic, non-metallic, oxide, nitride or carbide material, which may or may not be crystalline. Suitable hard materials are well known in the art and are readily commercially available.

As used herein, an elastomer is a polymer having the property of elasticity, whereby the polymer deforms in response to the application of stress, and substantially recovers its original form when the stress is removed. Elastomers typically have a low Young's modulus and a high yield strain, as is well known in the art. Suitable elastomers include, without limitation, natural or synthetic rubbers, polyurethanes, thermoplastic polymers, and other thermoset polymers.

In one embodiment, the liner (12) is embedded with a plurality of wear-resistant segments (20). The segments (20) may be present throughout the entire conduit, or localized in high wear locations. The segments are preferably separated by gaps (18) which are filled by the elastomer.

The segments (20) may have a three-dimensional shape including, without limitation, tiles, blocks, cylinders, spheres, or ovoids. The segments may have a two-dimensional shape which faces the conduit bore including, without limitation, squares, rectangles, circles, ovals, hexagons or other polygons, or combinations thereof. The hard material segments should be thick enough to resist the expected bending stress under impact conditions.

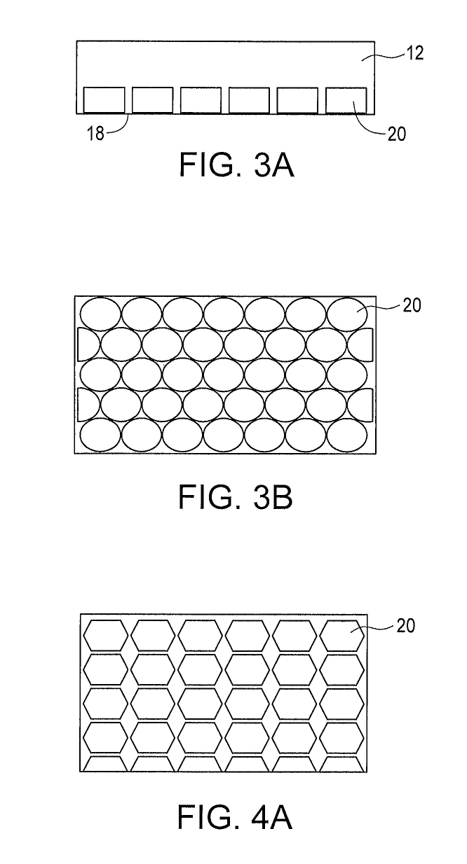

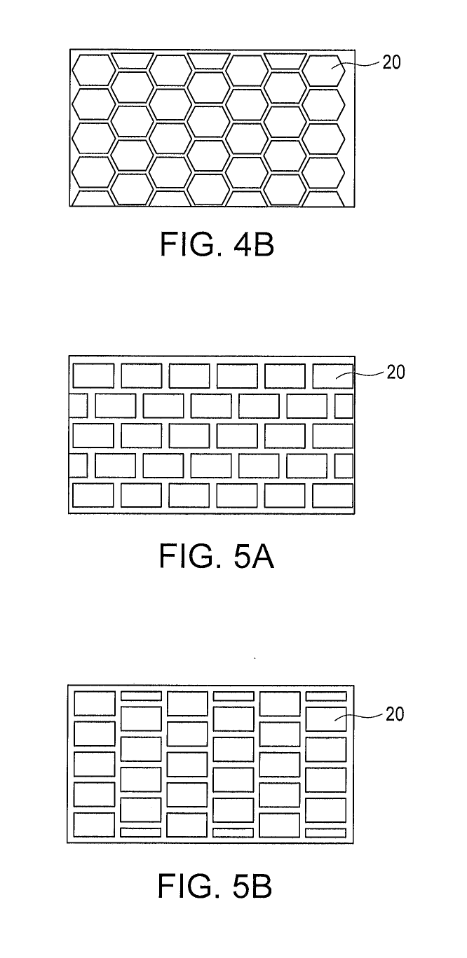

For example, in one embodiment, the segments (20) are tiles as shown in FIG. 1. The tiles may be flat or curved according to the curvature of the conduit bore. In another embodiment, the segments (20) are spherical, as shown in FIGS. 2A and 2B. In another embodiment, the segments (20) are cylindrical, embedded in an upright orientation, as is shown in FIGS. 3A and 3B. Alternatively, cylindrical segments (20) may be embedded longitudinally. In another embodiment, the segments (20) may be tiles which have a hexagonal two-dimensional shape, as shown in FIGS. 4A and 4B. In FIG. 4B, the segments are spaced much closer together, reducing the surface area of elastomer which is exposed to the fluid flowing in the bore In another alternative, the segments (20) comprise tiles having a rectangular two-dimensional shapes. The rectangular segments may be staggered in at least one direction, for example, axially (FIG. 5A) or longitudinally (FIG. 5B).

As may be apparent, there are numerous options as to the shape and configuration of the segments (20), and the above exemplary description of alternatives should not be considered limiting of the claimed invention.

The segments (20) present a wear-resistant hard face to the material flowing in the conduit bore, while being backed by and surrounded by a resilient elastomer material. In one embodiment, the segments are substantially level with the surrounding elastomer in order to present a smooth bore for the fluid flowing in the conduit. The elastomer gaps (18) between segments provide some energy dampening capacity in the longitudinal direction. The elastomer backing (12) absorbs a significant amount of impact energy from larger slurry particles, thereby reducing the risk of fracture damage of the segments.

In embodiments of the invention, the elastomeric liner (12) provides an energy dampening function to mitigate the impact damage on the hard material segments (20). Accordingly, the thickness of the wear-resistant segments and the elastomeric liner backing may be configured to minimize the propensity of the segments to crack in response to particle impact. The shape and size of the hard material segment; the degree of energy absorbing capability of the elastomer; and the environmental conditions such as solid particle size, impact velocity, temperature, etc. may also be factors to consider.

In one embodiment, the thickness of hard material segments is in the range of about 5 to about 50 mm, while the thickness of the elastomer backing may be in the range of about 5 mm to about 100 mm. The elastomer backing must be thick enough, having regard to its energy dampening capacity, to adequately cushion impacts to the hard material segments. In one embodiment, the ratio of the hard material segment thickness to the elastomer backing thickness may be about 1:1 to about 1:4.

In one particular embodiment, the segments comprise planar tungsten carbide tiles (30) having a thickness of about 13 mm, while the elastomer comprises a rubber layer having a thickness of about 38 mm. The tiles are spaced apart by gaps (18) which are about 13 mm wide.

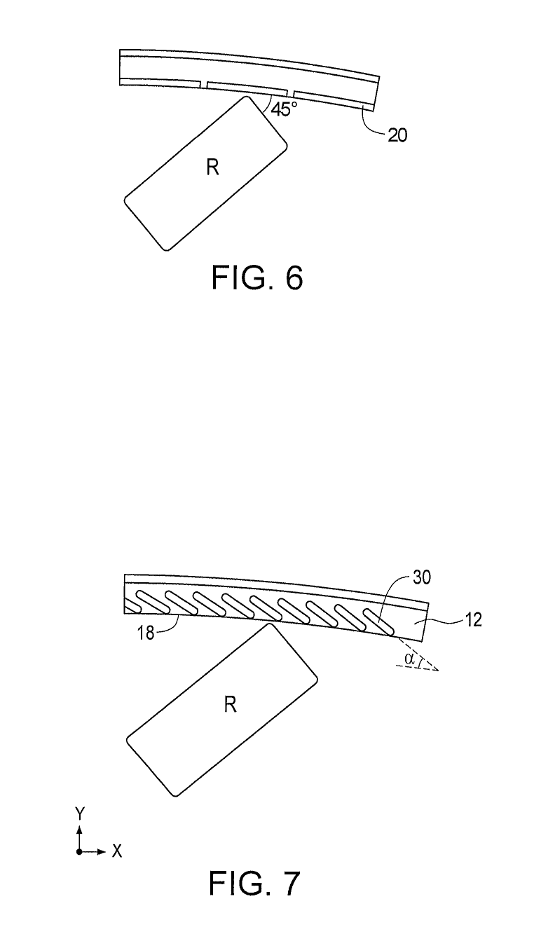

Simulations using finite element analysis indicate that impact stress on the segments (20) may be decreased by up to about 80% because of the elastomer backing layer. FIG. 6 shows a schematic of one simulation configuration. The test conditions shown in FIG. 6 considered the simulated impact of a rock (R) which impacts a tungsten carbide tile (20) at an angle of 45°.

In an alternative embodiment, the wear-resistant segments may be planar tiles (30) which are embedded in the elastomeric liner at an angle, preferably angled towards the direction of flow within the conduit such that rocks that impact the tiles are likely to do so at a direct angle, as opposed to an oblique angle. Specifically, as shown in FIG. 7, the tiles (30) may be angled at an angle α, which may be range from about 5° to about 90°, and preferably between about 10° and 45°, and more preferably between about 20° and 30°. This angle α is measured from a plane which is parallel to a central axis of a conduit which is straight, or a plane tangential to the central axis of a conduit which is curved. If angle α is 0°, then the tile is parallel to the central axis, or a plane tangential to the central axis.

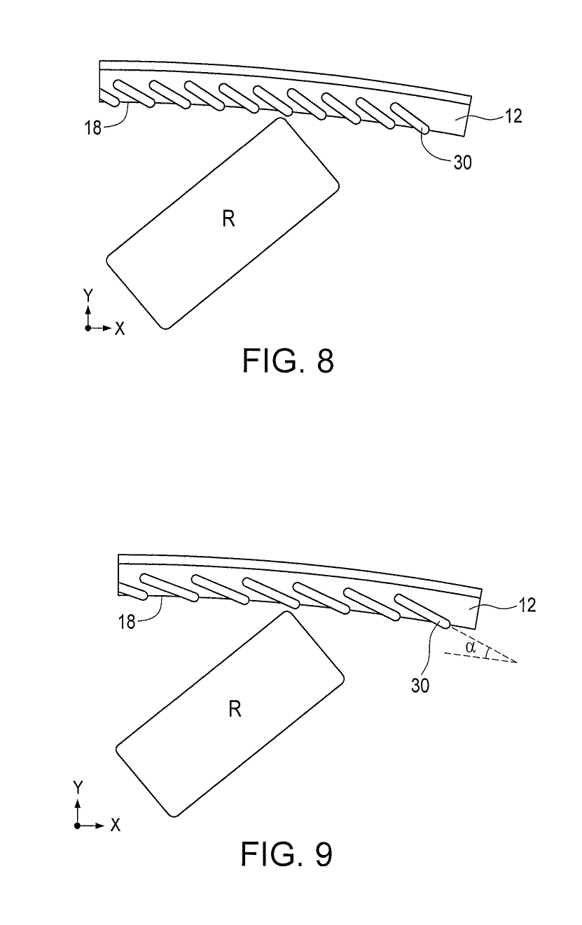

In one embodiment as shown in FIG. 7, less of the surface area of the inner bore is a hard material wear-resistant surface, but may have a greater impact absorption capability. The elastomer surface may then wear away, exposing more of the tiles (30), such that the tiles may protrude slightly from elastomer liner (12), as shown schematically in FIG. 8. Simulation testing has shown that while maximum principal stresses caused by rock impacts increase when the elastomer wears away, the peak stresses are still below the level which would cause fracture of tungsten carbide tiles of sufficient thickness. Maximum principal stresses in the hard material tiles may be reduced by increasing tile thickness.

Maximum principal stresses in the elastomer may be decreased by increasing the hard material tile thickness. The angle α does not appear to have a significant effect on elastomer maximum principal stress.

The interface adhesion strength between the hard material segments and the elastomer layer must be greater than the forces which would tend to separate the two. In a preferred embodiment, the interface adhesion between the two includes chemical bonding. Without chemical bonding, cured elastomer adheres to the metal surface by means of physical interlock at the microscopic level. It is common practice when using adhesives to bond polymers and metal to deliberately increase the surface roughness of the metal component to promote this microscopic interlock. Chemical bonding provides adhesion at the molecular bond level, and may work well even with polished surfaces. Instead of microscopic material shear provided by the mechanical interlock of surface roughness, adhesion is created via atomic forces. For this reason, such bonds can exceed the shear resistance of the elastomer itself. If one were to forcibly separate the bonded components so described, the bond surface would be covered with a thin layer of the elastomer. Such destructive testing is commonly employed in the manufacture of elastomeric-metal composites. Examples of such are well described in the American Society for Testing and Materials (ASTM) publication: ASTM D429-14, Standard Test Methods for Rubber Property—Adhesion to Rigid Substrates.

Chemical bonding may be exemplified by, but is not limited to, the type of vulcanized bond commonly used in vibration isolation components, automotive tires, conveyor belts, and other rubber-metal composites known in other arts.

In one embodiment, a bonding agent is used, and may comprise a single coat material placed between the hard material and the elastomer. The bonding mechanisms of the multiphase systems involved in making elastomer to hard material bonds are complex and the chemistry of the reactions involved may not be totally disclosed or understood in the art. Descriptions of such bonds may be found in the prior art, such as U.S. Pat. No. 6,632,319 assigned to Bridgestone Corporation, and U.S. Pat. No. 5,268,404 assigned to Lord Corporation, the entire contents of which are incorporated herein by reference, where permitted.

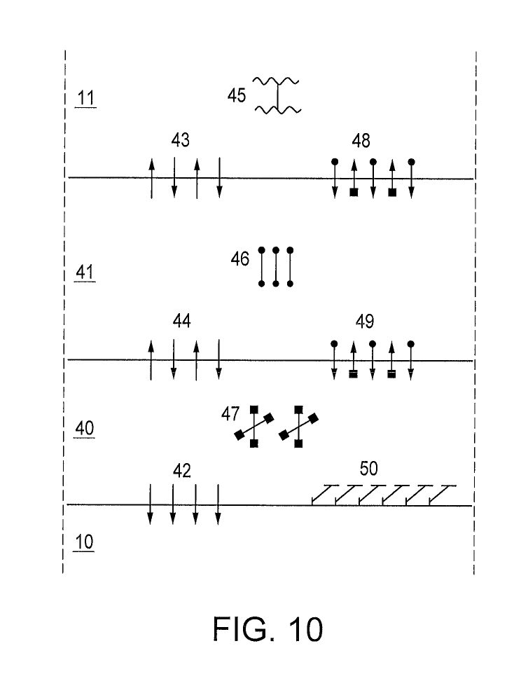

Therefore, in one embodiment, and depending on the specific elastomer and hard material, an additional primer coat may be applied to the hard material, and a cover coat is applied thereon which adheres between the elastomer and the primer. Such a two-coat primer and bonding agent system is shown schematically in FIG. 10.

A primer layer (40) and adhesive layer (41) is shown between the hard material (10) and the elastomer (11). Prior to curing, chemical agents in the primer layer (40) diffuse into the substrate material (10, 12) by chemisorption as illustrated by arrows (42). Chemical agents in the adhesive layer 41 diffuse into the elastomer layer (11) as illustrated by arrows (43). In addition, chemical agents inter-diffuse between the primer and adhesive layers (40, 41) as shown by arrows (44).

Upon curing, crosslinks (45) form between the polymer chains in the elastomer. Internal crosslinks are formed between the polymer chains of the adhesive layer (41) as depicted by (46). And similarly, internal crosslinks (47) are formed between the polymer chains of the primer layer (40).

Crossbridging reactions then form chemical bonds or linkages (48, 49, 50) between the respective layers which have been assisted by the chemisorption, and inter-diffusion as described above.

Those skilled in the art are aware that creating an effective chemical bond between an elastomer and a hard material requires suitable surface preparation. Any contamination of the surfaces at any interface will reduce the bond strength. For example, to prepare a metal surface, all traces of oil, grease or solid lubricant must be completely removed from the metal surface. Degreasing and shot blast, and wet blast followed by a phosphate conversion methods are suitable.

### DEFINITIONS AND INTERPRETATION

The singular forms “a,” “an,” and “the” include plural reference unless the context clearly dictates otherwise. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range of values includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

What is claimed is:

1. A conduit defining an inner bore and having an elastomeric liner comprising at least one hard material segment embedded in and backed by the elastomeric liner, and exposed to the inner bore.

2. The conduit of claim 1 comprising a plurality of hard material segments exposed to the inner bore.

3. The conduit of claim 1 which is a pipe.

4. The conduit of claim 1 which is a hose.

5. The conduit of claim 1 wherein the elastomeric liner comprises a rubber or a polyurethane.

6. The conduit of claim 1 wherein the hard material segment comprises tungsten carbide, or sintered tungsten carbide, a cermet, or a ceramic material.

7. The conduit of claim 6 wherein the 3-D shape of hard material segment comprises tiles, blocks, cylinders, spheres, or ovoids.

8. The conduit of claim 6 wherein the 2-D shape of hard material segment which faces the conduit bore comprises squares, rectangles, circles, ovals, hexagons or other polygons, or combinations thereof.

9. The conduit of claim 7 wherein the tiles are parallel to or angled away from a plane which is parallel to a central axis of a conduit which is straight, or a plane tangential to the central axis of a conduit which is curved.

10. The conduit of claim 9 wherein the tiles are angled away at about 0° to about 90°.

11. The conduit of claim 1 wherein the thickness of hard material segments is in the range of about 5 to about 50 mm and the elastomer backing is in the range of about 5 mm to about 100 mm.
